(19) United States
(12) Patent Application Publication
(10) Pub. No.: US 2011/0235083 A1
(43) Pub. Date: Sep. 29, 2011

(54) IMAGE FORMING APPARATUS AND POWER SUPPLY CONTROL METHOD FOR AN IMAGE FORMING APPARATUS

(75) Inventor: Atsushi SUZUKI, Osaka (JP)

(73) Assignee: KYOCERA MITA CORPORATION, Osaka (JP)

(21) Appl. No.: 13/036,333

(22) Filed: Feb. 28, 2011

(30) Foreign Application Priority Data
Mar. 29, 2010 (JP) 2010-075281

(51) Int. Cl. G06F 15/00

(52) U.S. Cl. 358/1.14; 358/1.15

(57) ABSTRACT

Provided is an image forming apparatus, including: a system control section that performs control of the apparatus; a functional block that forms a part of the image forming apparatus; and a power control section that is communicably connected to the system control section, that controls power supply to the system control section and the functional block, that is provided with data for power control defining with regard to the power supply to the system control section and the functional block by the system control section, and that controls the power supply to the system control section and the functional block based on the data for power control.

This application is based upon and claims the benefit of priority from the corresponding Japanese Patent Application No. 2010-075281 filed on Mar. 29, 2010, the entire contents of which are incorporated herein by reference.

### BACKGROUND OF THE INVENTION

1. Field of the Invention

The present invention relates to power management for an image forming apparatus such as a copying machine, a multifunction peripheral, a printer, or a facsimile machine.

2. Description of Related Art

In recent years, development for achieving power savings is being performed even in the field of an image forming apparatus such as a copying machine or a printer. On the other hand, there are also demands for improvement in throughput of the image forming apparatus such as improvement in resolution of image data to be handled or other such improvement. In general, the improvement in the throughput of the image forming apparatus necessitates speed enhancement of a drive clock and improvement in printing speed. Therefore, power consumption thereof is likely to increase compared to conventional image forming apparatuses. Against this backdrop, in recent years, there is a case where power management is performed in units of parts (devices) included in the image forming apparatus to thereby produce a power saving effect.

For example, there is known an image processing device including: a plurality of devices for executing a job; a first storage means in which a plurality of power consumptions of the plurality of devices are recorded for each operation mode of the devices; and control means for comparing a total power consumption of the devices that are processing a job with a predetermined threshold value and changing an operation mode of the devices that are processing the job when the total power consumption exceeds the threshold value. For example, it is determined whether or not to change an operation state of an image output device and other devices to low power based on whether or not there is a job being print ready. With this configuration, peak power during the operation is to be suppressed without lowering productivity.

First, the image forming apparatus may be configured in units of a plurality of functional blocks. For example, a multifunction peripheral is configured by combining a plurality of functional blocks such as an engine section for forming an image, a scanner section for reading a document, an operation panel section for inputting settings and displaying states. Further, optional devices such as a document transport device, a post-processing device, and a sorter may be attached to the image forming apparatus. Each of the optional devices may be regarded as one functional block.

In addition, the image forming apparatus may be provided with a power control section for managing and controlling power supply to the respective functional blocks and optional devices. For example, when entering a power saving mode, the power control section stops the power supply to the functional block. Further, for example, when recovering from the power saving mode, the power control section restarts the power supply to the functional blocks.

However, for example, the functional block provided to one model is not always provided to another model. Further, even when the same functional block is provided thereto, a value, a kind, or the like of a voltage to be input to the functional block may vary. Further, a kind and a format of the optional device that can be attached are different depending on the model of the image forming apparatus.

Up to now, under the above-mentioned circumstances, in order to finely manage the power supply within the image forming apparatus and achieve power savings, different power control sections are mounted depending on the model and perform different operations (ON/OFF of the power supply to the respective functional blocks). In other words, the power control section is individualized for each model. For example, a program for the power control section is created for each model. Further, components (for example, mounted CPU) of the power control section vary depending on the model.

Such individualization of the power control section for each model may cause a problem of bloating and complicating a power management system. Further, there is another problem in that it is difficult to provide commonality between models of the image forming apparatus in terms of the configuration of the power control section itself and the wirings involving the power control section.

Note that, when the total power consumption exceeds the threshold value, the above-mentioned known image processing device changes the operation mode of the devices to thereby suppress the peak power during the operation. In a case where the respective devices require a plurality of operation modes, not only control of the power control section but also control of the respective devices becomes complicated. Further, suppressing of the peak power and stopping of the power supply in the power saving mode are different in control contents in spite of sharing the point of suppressing power consumption. Accordingly, the known image processing device cannot solve the problem of bloating and complicating the power management system or the problem in that it is difficult to provide commonality between the models of the image forming apparatus.

### SUMMARY OF THE INVENTION

The present invention has been made in view of the above-mentioned problems of the conventional technology, and objects thereof are to simplify a power management system and to achieve commonality of a power control section between models of an image forming apparatus.

In order to solve the above-mentioned problems, an image forming apparatus according to an aspect of the present invention includes: a system control section that performs control of the image forming apparatus; a functional block that communicates with the system control section and forms a part of the image forming apparatus; and a power control section that is communicably connected to the system control section, that controls power supply to the system control section and the functional block, that is provided with data for power control defining with regard to the power supply to the system control section and the functional block by the system control section, and that controls the power supply to the system control section and the functional block based on the data for power control.

Further, in order to solve the above-mentioned problems, a power supply control method for an image forming apparatus according to another aspect of the present invention includes: providing, by a system control section that performs control of the image forming apparatus, data for power control defining with regard to the system control section, a functional block that forms a part of the image forming apparatus, and the power supply to the functional block, to a power control section that is communicably connected to the system control section and controls power supply to the system control section and the functional block; and controlling, by the power control section, the power supply to the system control section and the functional block based on the data for power control.

According to the above-mentioned aspects of the present invention, differences in the power management between the models of the image forming apparatus are absorbed into differences in data for power control. As in the conventional technology, the program for the power control section and the configuration of the power control section can be used in common without having to be changed according to the models. Accordingly, it is possible to simplify the power management system and use the power control section generally between the models. Further, it is possible to reduce development costs. Further, it is possible to reduce manufacture costs owing to mass production effect and the like.

Further features and advantages of the present invention become clearer from the description of an embodiment given below.

### BRIEF DESCRIPTION OF THE DRAWINGS

FIG. 1 is a schematic front sectional view illustrating an example of a multifunction peripheral according to an embodiment of the present invention.

FIG. 2 is a schematic front sectional view illustrating an example of a post-processing device according to the embodiment.

FIG. 3 is a plan view illustrating an example of an operation panel of the multifunction peripheral according to the embodiment.

FIG. 4 is a block diagram illustrating an example of a hardware configuration of the multifunction peripheral according to the embodiment.

FIG. 5 is a block diagram illustrating an example of a power supply system of the multifunction peripheral according to the embodiment.

FIG. 6 is a block diagram illustrating a detailed example of the power supply system of the multifunction peripheral according to the embodiment.

FIG. 7 is a flowchart illustrating an example of shift control from a normal mode to a power saving mode which is performed on the multifunction peripheral according to the embodiment.

FIG. 8 and FIG. 9 are explanatory diagrams illustrating examples of a power control table according to the embodiment.

FIG. 10 is an explanatory block diagram of an interrupt according to the embodiment.

FIG. 11 is a flowchart illustrating an example of recovery control from the power saving mode to the normal mode which is performed on the multifunction peripheral according to the embodiment.

FIG. 12 is an explanatory diagram illustrating an example of a setting screen of the power control table which is displayed on the multifunction peripheral according to the embodiment.

### DETAILED DESCRIPTION OF PREFERRED EMBODIMENTS

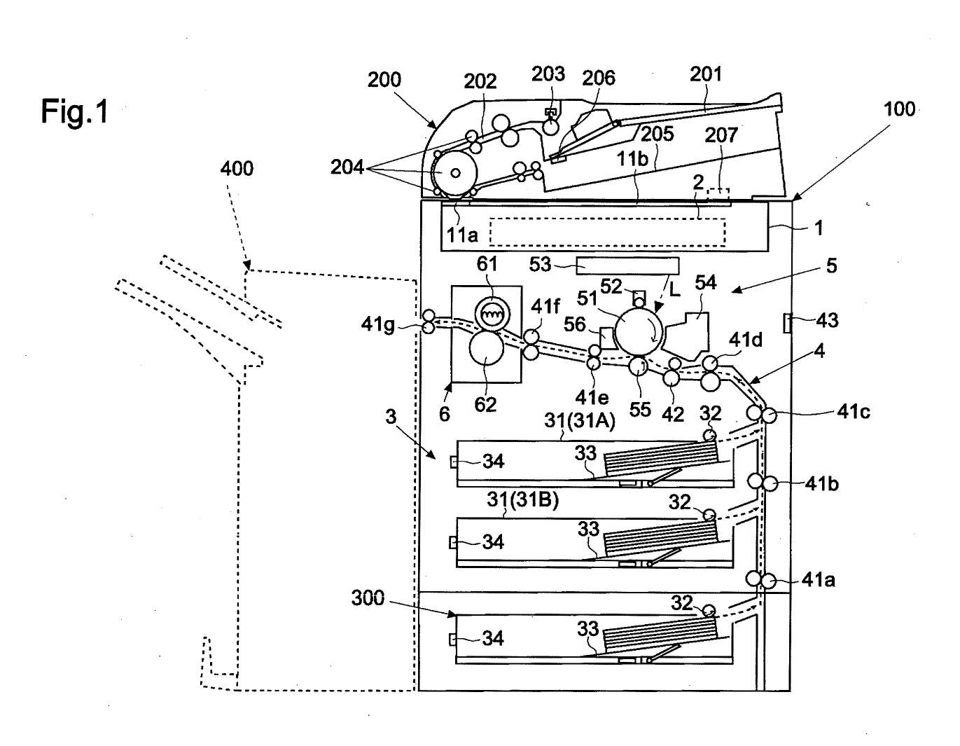

Hereinafter, an embodiment of the present invention is described with reference to FIG. 1 to FIG. 12. Note that, this embodiment is described by taking a multifunction peripheral 100 (corresponding to an image forming apparatus) as an example. However, components, layouts, and other such elements described in this embodiment should not limit the scope of the present invention, and are merely used as examples for the sake of description.

(Outline Structure of Multifunction Peripheral 100)

First, FIG. 1 is referenced to describe an outline of a multifunction peripheral 100 according to the embodiment of the present invention. FIG. 1 is a schematic front sectional view illustrating an example of the multifunction peripheral 100 according to the embodiment of the present invention.

The multifunction peripheral 100 of this embodiment is provided with a document transport device 200 (optional device) located at the uppermost level thereof. The document transport device 200 transports documents stacked on a document placing tray 201 sheet by sheet to a reading position of an image reading section 1. A plurality of documents to be copied, scanned, and the like are placed on the document placing tray 201. Then, a document feeding roller 203 is provided at the upstream end of a document transport path 202 so as to be in contact with a document placed at the top level. Further, a plurality of document transport roller pairs 204 are provided along the document transport path 202. The plurality of document transport roller pairs 204 transport the document to the reading position (position above the contact glass 11a for reading in transfer) and a document delivery tray 205.

Note that, a document placement detection sensor 206 (corresponding to an interrupt generation section) is provided to the document placing tray 201 in order to detect placement of a document. The document placement detection sensor 206 is, for example, an optical sensor. An output from the document placement detection sensor 206 changes according to whether or not a document is placed.

Further, the document transport device 200 is opened by being lifted upward about a fulcrum (not shown) provided on a depth side of the paper surface of FIG. 1. For example, a document such as a book can be placed on a contact glass 11b for reading in placement provided on an upper surface of the image reading section 1. Note that, as indicated by the broken line in FIG. 1, an open/close detection sensor 207 (corresponding to the interrupt generation section) is provided for detecting an open/closed state of the document transport device 200. The open/close detection sensor 207 may be any sensor as long as the open/closed state can be detected. For example, the open/close detection sensor 207 may be an interlocking switch that is brought into contact with a lower surface of the document transport device 200 or may be a reflective optical sensor.

Next, as indicated by the broken line in FIG. 1, an operation panel 2 is provided on an upper portion of a front surface. The operation panel 2 functions as an input section for performing settings on printing such as copying, and also displays various kinds of information (corresponding to a setting input section). Further, the image reading section 1, a sheet feeding portion 3, a transport path 4, an image forming portion 5, a fixing portion 6, and the like are provided to a main body of the multifunction peripheral 100.

The image reading section 1 reads a document, and generates image data. The contact glasses 11 (two kinds of 11a and 11b) are provided on the upper surface of the image reading section 1. An internal portion of the image reading section 1 is provided with optical members (not shown) such as a moving frame (including an exposure lamp and a mirror) (not shown) that moves in a horizontal direction (lateral direction in FIG. 1) and a lens and an image sensor (for example, CCD). For example, when documents being continuously transported are read by the document transport device 200, the moving frame is fixed below the contact glass 11a for reading in transfer, and reflected light from each of the documents is introduced to the lens and the image sensor. Further, when a document placed on the contact glass 11b for reading in placement is read, the moving frame is caused to move in the horizontal direction, the reflected light from the document is introduced to the lens and the image sensor.

The image reading section 1 uses those optical members to apply light to the document. In addition, the image reading section 1 analog-to-digital converts an output value from each pixel of the image sensor that has received the reflected light from the document, and generates image data. Based on the read image data, the multifunction peripheral 100 can perform printing (copy function).

The sheet feeding portion 3 includes cassettes 31 (31A and 31B) as standard equipment, and two cassettes 31 in total are stacked in a vertical direction. In addition, an optional cassette 300 as an additional optional device is attached below the sheet feeding portion 3. The sheet feeding portion 3 and the optional cassette 300 accommodate a plurality of (for example, approximately 500 to 1000) stacked sheets of paper having different kinds (for example, plain paper, copy paper, and recycled paper) and different sizes (for example, letter size, A4, A3, B4, and B5). Note that, each of the cassettes 31 (31A and 31B) and the optional cassette 300 have the same structure, and hence the same members are denoted by the same reference symbols.

A sheet feeding roller 32 is provided to each of the respective cassettes 31 (31A and 31B) and the optional cassette 300. Each of the sheet feeding rollers 32 is driven to rotate in order to supply paper. Further, a paper placing plate 33, on which paper is placed, is provided within each of the respective cassettes 31 (31A and 31B) and the optional cassette 300. Each of the paper placing plates 33 has an end portion on an upstream side of a sheet transporting direction as a fulcrum and an end portion on a downstream side of the sheet transporting direction as a free edge. The free edge moves in a vertical direction.

Further, the respective cassettes 31 and the optional cassette 300 are detachably attached so as to allow addition of paper, and are provided with an attachment/detachment detection sensor 34 (corresponding to the interrupt generation section). The attachment/detachment detection sensor 34 is provided in order to detect whether each of the respective cassettes 31 and the optional cassette 300 is attached to or detached from the multifunction peripheral 100. The attachment/detachment detection sensor 34 may be any sensor as long as an attached/detached state can be detected. For example, the attachment/detachment detection sensor 34 may be an interlocking switch that is brought into contact with one surface of each of the respective cassettes 31 (31A and 31B) or may be a reflective optical sensor. Note that, when the respective cassettes 31 and the optional cassette 300 are each attached, the paper placing plate 33 is urged upward. This brings a paper sheet placed at the top level into contact with the sheet feeding rollers 32.

Next, the transport path 4 is a passage along which the paper sheet is transported within the apparatus. The transport path 4 is provided with a plurality of transport roller pairs 41 (in FIG. 1, seven transport roller pairs 41a to 41g in total are illustrated in order from the upstream) that are driven to rotate when the paper sheet is transported, a registration roller pair 42 that causes the paper sheet being transported to wait before the image forming portion 5 and sends out the paper sheet at a timing corresponding to formation of a toner image, and the like.

Note that, the multifunction peripheral 100 of this embodiment has a front cover (not shown) that can be opened and closed for removal of jammed paper or for maintenance. A cover open/close detection sensor 43 (corresponding to the interrupt generation section) is provided for detecting the opening/closing of the front cover. The cover open/close detection sensor 43 may be any sensor as long as the opening/closing of the front cover can be detected. For example, the cover open/close detection sensor 43 may be an interlocking switch that is brought into contact with a part of the front cover or may be an optical sensor.

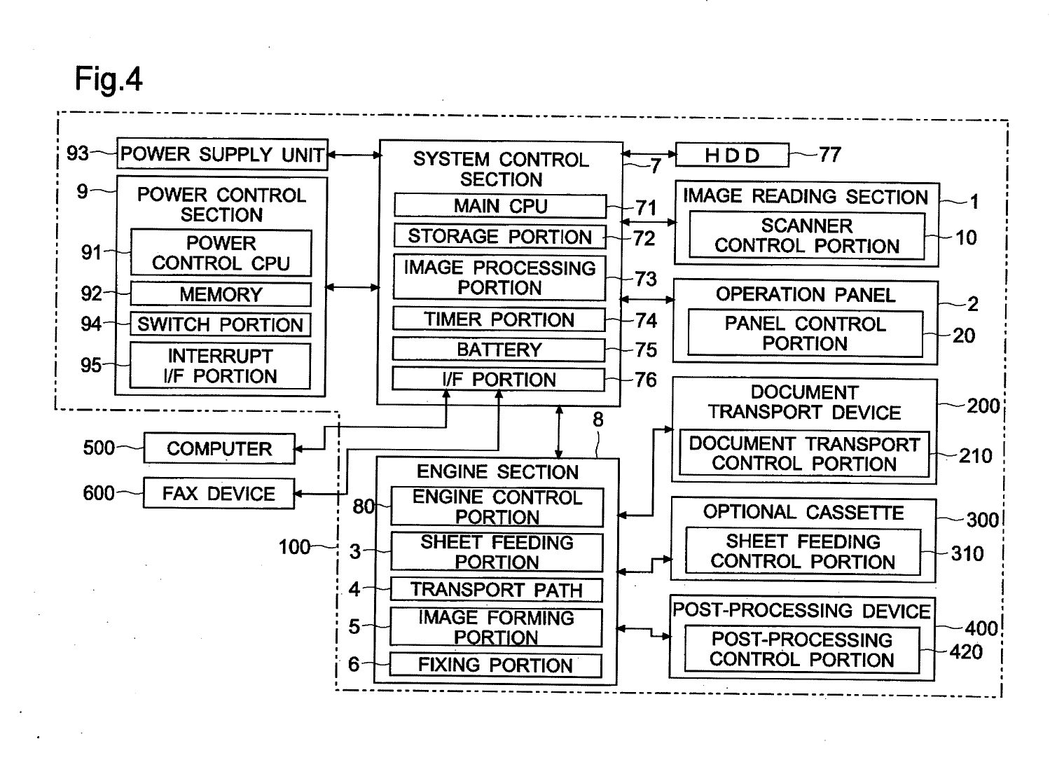

The image forming portion 5 forms an image (toner image) based on the image data, and transfers the toner image onto the paper sheet being transported. Note that, the image data used here includes the image data on the document acquired by the image reading section 1 and the image data transmitted from a computer 500 (illustrated in FIG. 4) which is connected to the multifunction peripheral 100.

The image forming portion 5 includes a photosensitive drum 51 supported so as to be able to be driven to rotate in a direction indicated by the arrow illustrated in FIG. 1, a charging device 52, an exposure device 53, a developing device 54, a transferring roller 55, and a cleaning device 56, which are arranged around the photosensitive drum 51.

Next described are toner image formation and transfer process. The photosensitive drum 51 driven to rotate in a predetermined direction is provided substantially at a center of the image forming portion 5. The photosensitive drum 51 is charged to a predetermined potential by the charging device 52. An exposure device 53 outputs a laser beam L based on the image data, and scan-exposes a surface of the photosensitive drum 51 to form an electrostatic latent image corresponding to the image data. Then, the developing device 54 develops the electrostatic latent image by supplying toner thereto. The transferring roller 55 provided below the photosensitive drum 51 is in press contact with the photosensitive drum 51 to thereby form a nip. Then, the registration roller pair 42 causes the paper sheet to enter the nip at a suitable timing. When the paper sheet and the toner image enter the nip, a predetermined voltage is applied to the transferring roller 55. In this manner, the toner image is transferred onto the paper sheet from the photosensitive drum 51. After the transfer, the cleaning device 56 removes residual toner and the like from the photosensitive drum 51.

The fixing portion 6 fixes the toner image transferred onto the paper sheet. The fixing portion 6 according to this embodiment mainly includes a heat roller 61 incorporating a heating element and a pressure roller 62. The heat roller 61 and the pressure roller 62 are in press contact with each other to thereby form a nip. When the paper sheet passes through the nip, the toner is heated and fused, and the toner image is fixed to the paper sheet. The paper sheet having the toner fixed thereto is sent out toward a post-processing device 400.

(Post-Processing Device 400)

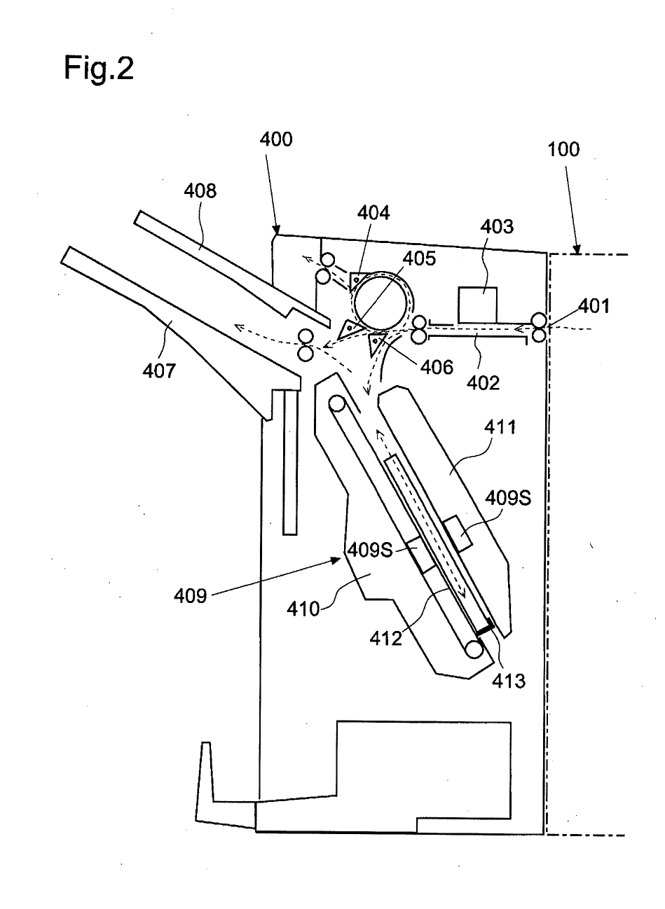

As indicated by the broken line in FIG. 1, the post-processing device 400 is connected to the multifunction peripheral 100 of this embodiment in order to perform a post-processing on the printed paper sheet. Thus, FIG. 2 is referenced to describe an example of the post-processing device 400 according to the embodiment of the present invention. FIG. 2 is a schematic front sectional view illustrating an example of the post-processing device 400 according to the embodiment of the present invention. Note that, a delivery tray (not shown) that receives printed paper sheets can be provided in place of the post-processing device 400.

The post-processing device 400 is connected to the multifunction peripheral 100. The post-processing device 400 performs the post-processing on the printed paper sheet. The printed paper sheet delivered from the multifunction peripheral 100 is introduced into the post-processing device 400 through an inlet 401 provided in an upper portion of a right side surface of the post-processing device 400. The post-processing device 400 has a punching portion 403 for performing a punching processing provided in the vicinity of the most upstream of a transport path 402. Switching claws 404, 405, and 406 for sorting paper sheets into different destinations are provided in a downstream of the punching portion 403.

Specifically, the paper sheets are sorted into a main delivery tray 407 provided on a left side surface portion of the post-processing device 400, a sub delivery tray 408 provided above the main delivery tray 407, a stapling portion 409, and the like. The stapling portion 409 performs a stapling processing by stacking the paper sheets introduced into the post-processing device 400 and setting a plurality of paper sheets as a paper stack every number of print copies.

The main delivery tray 407 receives the delivered paper stack that has been subjected to the stapling processing by the stapling portion 409. Note that, the main delivery tray 407 may also receive the delivered paper sheets that have not particularly been subjected to the post-processing and the paper sheets that have been subjected only to the punching processing. Meanwhile, the sub delivery tray 408 receives the delivered paper sheets that have not particularly been subjected to the post-processing and the paper sheets that have been subjected only to the punching processing. Note that, a delivery destination of the paper sheet can be specified by the operation panel 2 described later.

The stapling portion 409 performs a stacking processing for stacking a plurality of paper sheets every number of copies. The stapling portion 409 includes a stapler 409S having staples. The stapler 409S can perform various stapling processings including leading end binding for stapling a leading end of the paper stack and saddle stitching for binding the paper stack with two staples along its short-side direction in the center of its long-side direction.

As illustrated in FIG. 2, the stapling portion 409 includes a stack tray 410 in the lower part and a cover tray 411 in the upper part. A stopper 413 that moves along a sheet placing surface 412 of the stack tray 410 is provided. The paper sheets have the lower ends supported by the stopper 413 with the sheet surface covered with the cover tray 411, and are stacked on the stack tray 410. When the stacking processing or the stapling processing is performed, the stopper 413 is caused to move upward. As a result, the paper stack is transported upward and delivered onto the main delivery tray 407.

(Operation Panel 2)

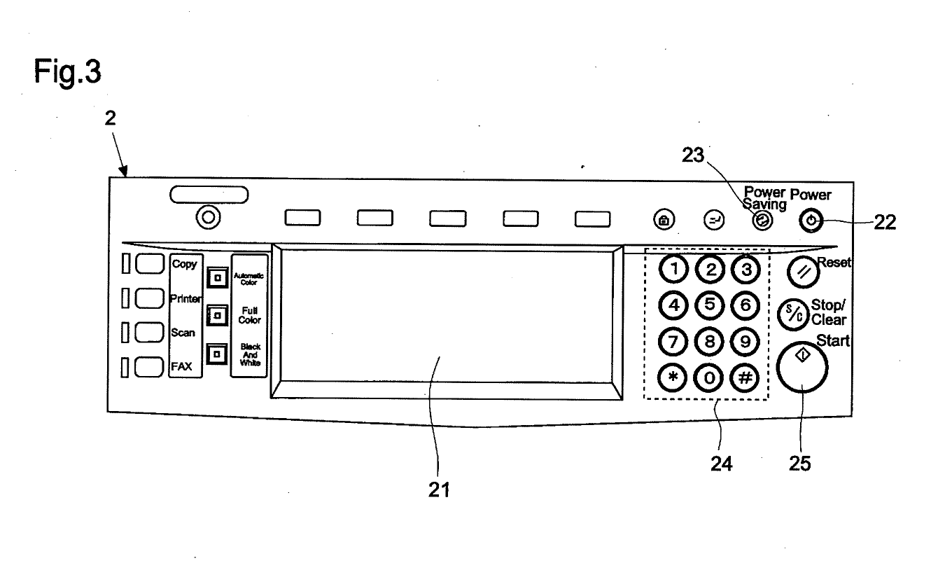

Next, FIG. 3 is referenced to describe an example of the operation panel 2 of the multifunction peripheral 100 according to the embodiment of the present invention. FIG. 3 is a plan view illustrating the example of the operation panel 2 of the multifunction peripheral 100 according to the embodiment of the present invention.

As indicated by the broken line in FIG. 1, the operation panel 2 is provided on the upper portion of the front surface of the multifunction peripheral 100. The operation panel 2 includes a liquid crystal display portion 21 (corresponding to a display portion) of a touch panel system and a plurality of keys such as a power key 22, a power saving key 23, a numerical keypad portion 24, and a start key 25.

The liquid crystal display portion 21 performs display related to printing. For example, the liquid crystal display portion 21 displays states of the printing, an error, and the like on the multifunction peripheral 100. Further, the liquid crystal display portion 21 displays keys and buttons for function settings (for example, paper size setting, enlargement/reduction setting, and density setting) for the multifunction peripheral 100. Then, a touch panel is used to detect coordinates of a depressed position. In this manner, the depressed key or button among the displayed keys and buttons is recognized by the operation panel 2. A user can set various functions of the multifunction peripheral 100.

The power key 22 is a key for instructing to turn on/off a main power of the multifunction peripheral 100. Note that, with regard to the power of the multifunction peripheral 100, another power switch (not shown) (for example, mechanical switch) may be provided in addition to the power key 22. The power saving key 23 is a key for instructing to shift the mode of the multifunction peripheral 100 to a power saving mode. The power saving key 23 is also a key for instructing to recover from the power saving mode to a normal mode. In other words, the power saving key 23 is a key for instructing to switch between the normal mode and the power saving mode. The numerical keypad portion 24 has a combination of keys of numerals and symbols including “0” to “9”, “*”, and “#”, and is used to perform the input of numerals such as the number of print copies and a FAX number. The start key 25 is depressed to instruct to start the operation after the settings are completed through the liquid crystal display portion 21, the numerical keypad portion 24, and the like.

(Hardware Configuration of Multifunction Peripheral 100)

Next, FIG. 4 is referenced to describe a hardware configuration of the multifunction peripheral 100 according to the embodiment of the present invention. FIG. 4 is a block diagram illustrating an example of the hardware configuration of the multifunction peripheral 100 according to the embodiment of the present invention.

As illustrated in FIG. 4, the multifunction peripheral 100 according to this embodiment includes a system control section 7 (control board) having a combination of various elements, circuits, and the like. Then, a combination of a plurality of functional blocks constitutes the multifunction peripheral 100. Provided as the functional block are the image reading section 1, the operation panel 2, an engine section 8, the document transport device 200, the optional cassette 300, the post-processing device 400, a power control section 9, and the like. The system control section 7 is communicably connected to those functional blocks. Then, the system control section 7 performs communications with the respective functional blocks to obtain information therefrom. Further, the system control section 7 controls the operations of the respective functional blocks.

The system control section 7 includes, for example, a main CPU 71, a storage portion 72, an image processing portion 73, a timer portion 74, a battery 75, an interface (I/F) portion 76.

The main CPU 71 is a processor of the system control section 7. The main CPU 71 performs processings and control based on data and programs stored in the storage portion 72. The storage portion 72 is formed by combining, for example, a nonvolatile storage device (flash ROM) and a volatile storage device (for example, RAM). The storage portion 72 stores the data and programs required for various kinds of control such as execution of a job. Note that, an HDD 77 can be connected to the system control section 7 as a mass storage device. The system control section 7 can use the HDD 77 as one of the storage devices. For example, the HDD 77 stores image data and the like in addition to the data and programs required for the various kinds of control.

The image processing portion 73 performs an image processing on the image data generated by the image reading section 1 or the image data input from an external portion. For example, the image processing portion 73 is configured of an ASIC dedicated to an image processing and a memory for an image processing. The image processing that can be performed by the image processing portion 73 greatly varies from an enlargement/reduction processing to density changing and the like, and details thereof is omitted on the assumption that known image processings can be executed.

Then, the image data that has undergone the image processing can be sent to the exposure device 53 for the printing (copy function and printer function). Further, the image data that has undergone the image processing can be stored in the HDD 77 (scanner function). Further, the image data that has undergone the image processing can be transmitted from the I/F portion 76 described later to the external portion (computer 500, FAX device 600, or the like) (scanner function and FAX function). Note that, the image processing portion 73 may be functionally implemented by the main CPU 71 and the storage portion 72.

The timer portion 74 is a circuit for measuring time. For example, the timer portion 74 a real time clock (RTC) chip. In addition, the system control section 7 is provided with the battery 75 so that the timer portion 74 operates even when the main power to the multifunction peripheral 100 is not turned on (when the multifunction peripheral 100 is not connected to a commercial power supply). On the other hand, when the main power to the multifunction peripheral 100 is turned on, the timer portion 74 operates by using, for example, power supplied to the system control section 7.

The I/F portion 76 is an interface for performing communications with the external computer 500 (for example, personal computer) and the external FAX device 600 via a network, a line, a cable, or the like. Therefore, the I/F portion 76 includes various connectors and a circuit, an element, a controller, and the like for the communications. By the communications performed via the I/F portion 76, the system control section 7 can receive data for printing from the external computer 500 or the external FAX device 600 and can transmit the image data to the external computer 500 or the external FAX device 600.

Next described are the respective functional blocks. First, the image reading section 1 (corresponding to the functional block) is provided with regard to the reading of a document. Provided in the image reading section 1 is a scanner control portion 10 that controls the actual operation of the image reading section 1 in response to an instruction from the system control section 7. The scanner control portion 10 is configured of, for example, a CPU and a memory. The scanner control portion 10 performs control of members included in the image reading section 1 such as turning on/off of the lamp, the operation of the image sensor, and transmission of the generated image data to the system control section 7 or the like.

Next, the operation panel 2 (corresponding to the functional block) is provided with regard to the inputting and displaying of settings on the multifunction peripheral 100. Provided in the operation panel 2 is a panel control portion 20 that controls an actual operation of the operation panel 2 in response to an instruction from the system control section 7. The panel control portion 20 is configured of, for example, a CPU and a memory. The panel control portion 20 performs control related to the members included in the operation panel 2 such as display control for the liquid crystal display portion 21, recognition of the coordinates depressed on the touch panel, recognition of the key displayed on the liquid crystal display portion 21, and depression of various hardware keys including the power key 22, the power saving key 23, and the start key 25.

Next, the engine section 8 (corresponding to the functional block) is provided with regard to the printing performed on the multifunction peripheral 100. The engine section 8 includes the sheet feeding portion 3, the transport path 4, the image forming portion 5, and the fixing portion 6 that are described above. In addition, an engine control portion 80 is provided within the engine section 8. The engine control portion 80 controls the actual operation of the engine section 8 in response to an instruction from the system control section 7. The engine control portion 80 is configured of, for example, a CPU and a memory. The engine control portion 80 performs control of members included in the engine section 8 such as the sheet feeding, the transport, the toner image formation, and temperature control of the fixing portion 6.

Further, with regard to the printing performed on the multifunction peripheral 100, the optional devices such as the document transport device 200, the optional cassette 300, and the post-processing device 400 are handled as the functional blocks. The system control section 7 issues an operation instruction for each of the optional devices to the engine section 8. Then, the engine section 8 issues the instruction to each of the optional devices. In other words, the engine section 8 supervisors the control related to the printing, the respective optional devices are regarded as dependent on the engine section 8. This is because the engine section 8 is essential for the printing and cannot be detached while the optional device is detachably attachable and the optional device to be attached varies according to the multifunction peripheral 100.

Further, a document transport control portion 210 that controls the actual operation of the document transport device 200 is provided within the document transport device 200 serving as the functional block. The document transport control portion 210 is also configured of, for example, a CPU and a memory. The document transport control portion 210 performs control of members included in the document transport device 200 such as detection of the placement of a document and the transport of a document.

Further, a sheet feeding control portion 310 that controls the actual operation of the optional cassette 300 is provided within the optional cassette 300 serving as the functional block. The sheet feeding control portion 310 is also configured of, for example, a CPU and a memory. The sheet feeding control portion 310 performs control of members included in the optional cassette 300 such as the sheet feeding.

Further, a post-processing control portion 420 that controls the actual operation of the post-processing device 400 is provided within the post-processing device 400 serving as the functional block. The post-processing control portion 420 is also configured of, for example, a CPU and a memory. The sheet feeding control portion 310 performs control of members included in the post-processing device 400 such as the transport, punching, stacking, and stapling of the printed paper sheets.

Further, the power control section 9 is provided with regard to power management for the multifunction peripheral 100. The power control section 9 controls the power supply to the respective components within the multifunction peripheral 100 according to the instruction from the system control section 7 and the data transmitted from the system control section 7. For example, the power control section 9 includes a power control CPU 91 serving as a processor and a memory 92 that stores data and a program for the power control section 9.

Further, an output from a power supply unit 93 is input to the power control section 9. The power supply unit 93 including a rectifier circuit, a voltage step-up circuit, and a voltage step-down circuit is connected to the commercial power supply, and generates a plurality of kinds of voltages required for the operation of the multifunction peripheral 100. In addition, the power control section 9 includes a switch portion 94 for turning on/off the power supply to the system control section 7 and the respective functional blocks. The power control section 9 causes the switch portion 94 to open/close the power supply line extending from the power supply unit 93 to the system control section 7 and the respective functional blocks. Accordingly, the power control section 9 controls the on/off of the power supply to the system control section 7 and the respective functional blocks. An interrupt I/F portion 95 receives an interrupt from the interrupt generation section that detects that the operation or the input has been performed with respect to the multifunction peripheral 100. When the multifunction peripheral 100 is in the power saving mode, the power control section 9 restarts the power supply to the system control section 7 and the respective functional blocks with the interrupt used as a trigger.

(Outline of Power Supply System)

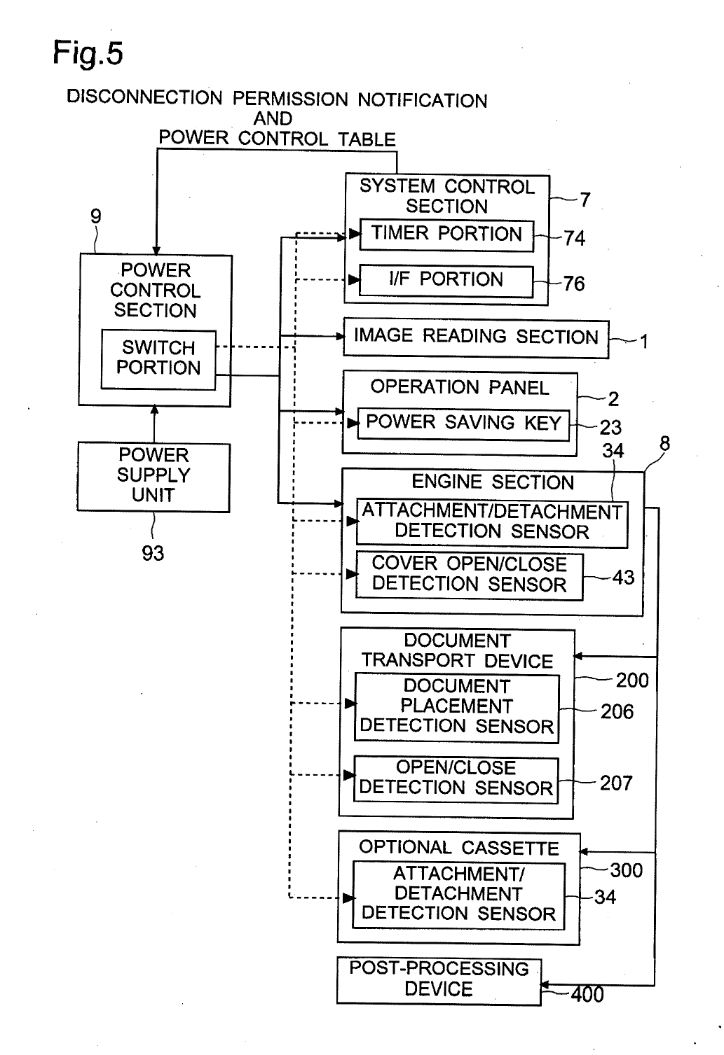

Next, FIG. 5 is referenced to describe an example of a power supply system of the multifunction peripheral 100 according to the embodiment of the present invention. FIG. 5 is a block diagram illustrating the example of the power supply system of the multifunction peripheral 100 according to the embodiment of the present invention.

As described above, the various voltages generated by the power supply unit 93 are input to the power control section 9. Then, the system control section 7 and the image reading section 1, the operation panel 2, and the engine section 8 that serve as the functional blocks receive supply of power through the intermediation of the power control section 9. Further, when the engine section 8 receives the power supply, the power is supplied to the document transport device 200, the optional cassette 300, and the post-processing device 400 that are the optional devices serving as the functional blocks.

(Details of Power Supply)

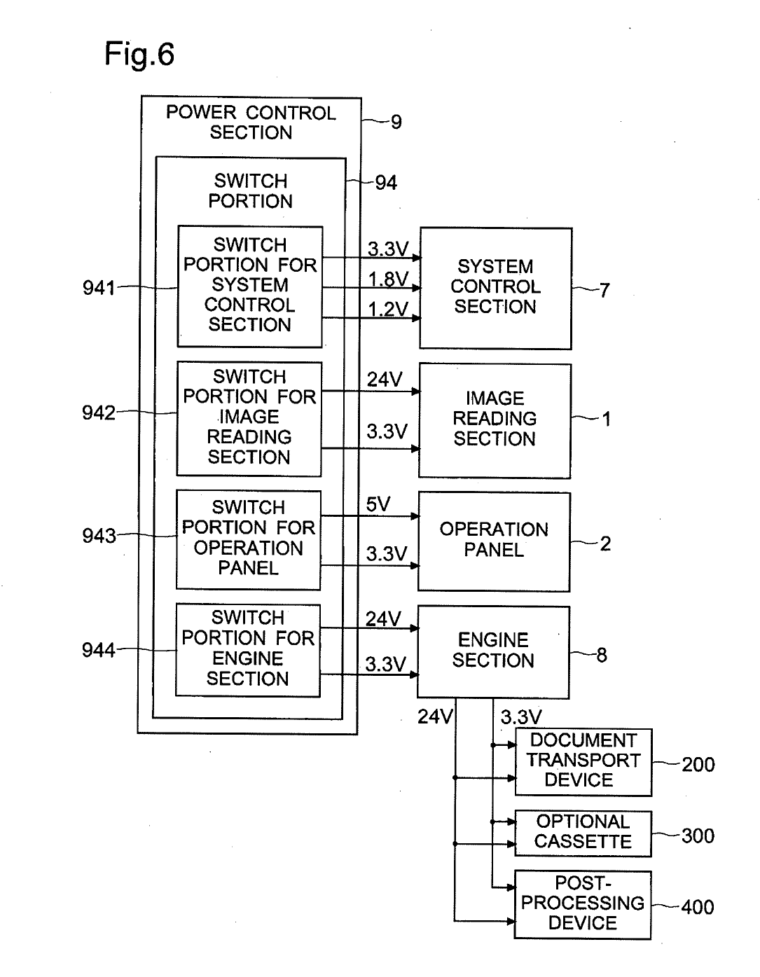

Next, FIG. 6 is referenced to describe a detailed example of the power supply system of the multifunction peripheral 100 according to the embodiment of the present invention. FIG. 6 is a block diagram illustrating the detailed example of the power supply system of the multifunction peripheral 100 according to the embodiment of the present invention.

As illustrated in FIG. 6, the switch portion 94 within the power control section 9 includes switch portions 94 of a plurality of kinds for the system control section 7 and for the respective functional blocks. For example, the switch portions 94 of a plurality of kinds for the system control section 7 and for the respective functional blocks include a plurality of semiconductor switches such as FETs or bipolar transistors, a plurality of mechanical switches, and use on/off states to control the power supply.

For example, there are three kinds of voltage values, namely, DC 3.3 V, DC 1.8 V, and DC 1.2 V, which are applied to the system control section 7 from a switch portion 941 for a system control section among the switch portions 94. For example, DC 3.3 V and DC 1.8 V are voltages for I/O blocks of the main CPU 71, and DC 1.2 V is a voltage for a core of the main CPU 71. Further, the storage portion 72, the image processing portion 73, the I/F portion 76, and the like are driven by any one of the voltages of DC 3.3 V, DC 1.8 V, and DC 1.2 V. In the multifunction peripheral 100 of this embodiment, the three kinds of voltages are thus supplied to the system control section 7. Note that, the number of kinds may vary from four or more to two or less according to the model of an image forming apparatus.

Next, there are two kinds of voltage values, namely, DC 24 V and DC 3.3 V, which are applied to the image reading section 1 from a switch portion 942 for an image reading section. For example, DC 3.3 V is a voltage for driving the scanner control portion 10. Further, DC 24 V is a voltage for driving a motor within the image reading section 1 that causes the lamp and the mirror to move. In the multifunction peripheral 100 of this embodiment, the two kinds of voltages are thus supplied to the image reading section 1. Note that, the number of kinds may vary from three or more to one according to the model of the image forming apparatus.

Further, there are two kinds of voltage values, namely, DC 5 V and DC 3.3 V, which are applied to the operation panel 2 from a switch portion 943 for an operation panel. For example, DC 3.3 V is a voltage for driving the panel control portion 20. Further, DC 5 V is a voltage for driving liquid crystal panel and a backlight of the liquid crystal display portion 21. In the multifunction peripheral 100 of this embodiment, the two kinds of voltages are thus supplied to the operation panel 2. Note that, the number of kinds may vary from three or more to one according to the model of the image forming apparatus.

Further, there are two kinds of voltage values, namely, DC 24 V and DC 3.3 V, which are applied to the engine section 8 from a switch portion 944 for an engine section among the switch portion 94. For example, DC 3.3 V is a voltage for driving not only the engine control portion 80 but also the document transport control portion 210, the sheet feeding control portion 310, and the post-processing control portion 420. Further, DC 24 V is a voltage for driving the motor that causes various rotary members (for example, photosensitive drum 51, sheet-feeding roller pair, and heat roller 61) to rotate in transporting a paper sheet or forming or fixing a toner image. Further, DC 24 V is also supplied to the respective optional devices in order to cause the motor to rotate. In the multifunction peripheral 100 of this embodiment, the two kinds of voltages are thus supplied to the engine section 8. Note that, the number of kinds may vary from three or more to one according to the model of the image forming apparatus.

(Shift to Power Saving Mode)

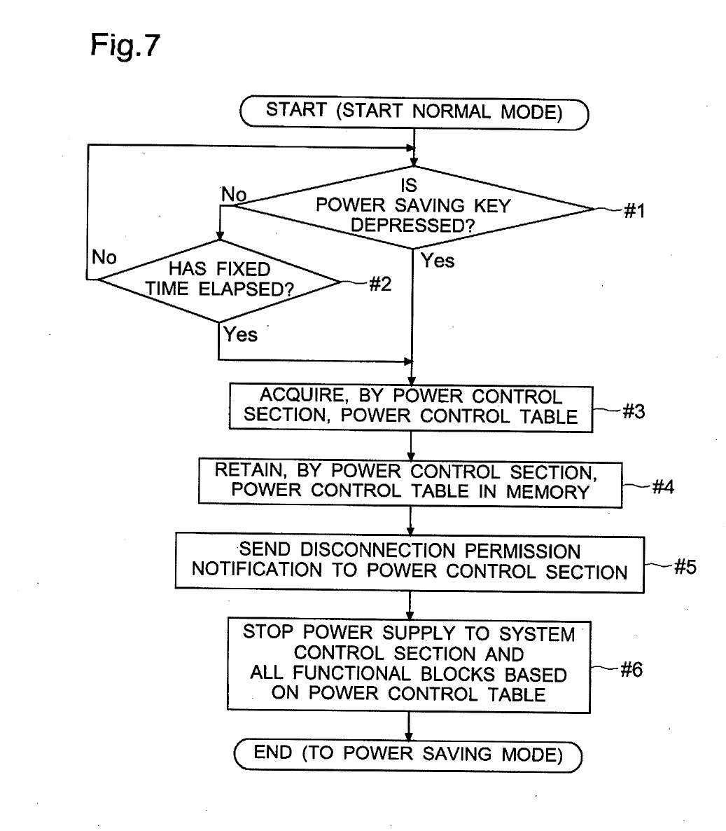

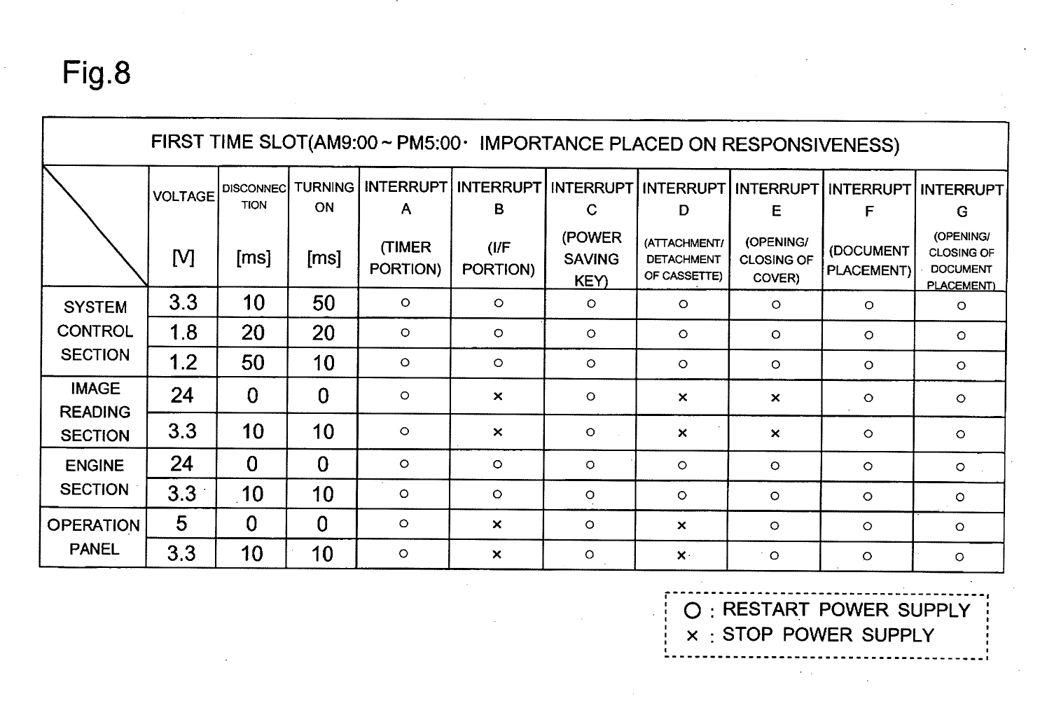

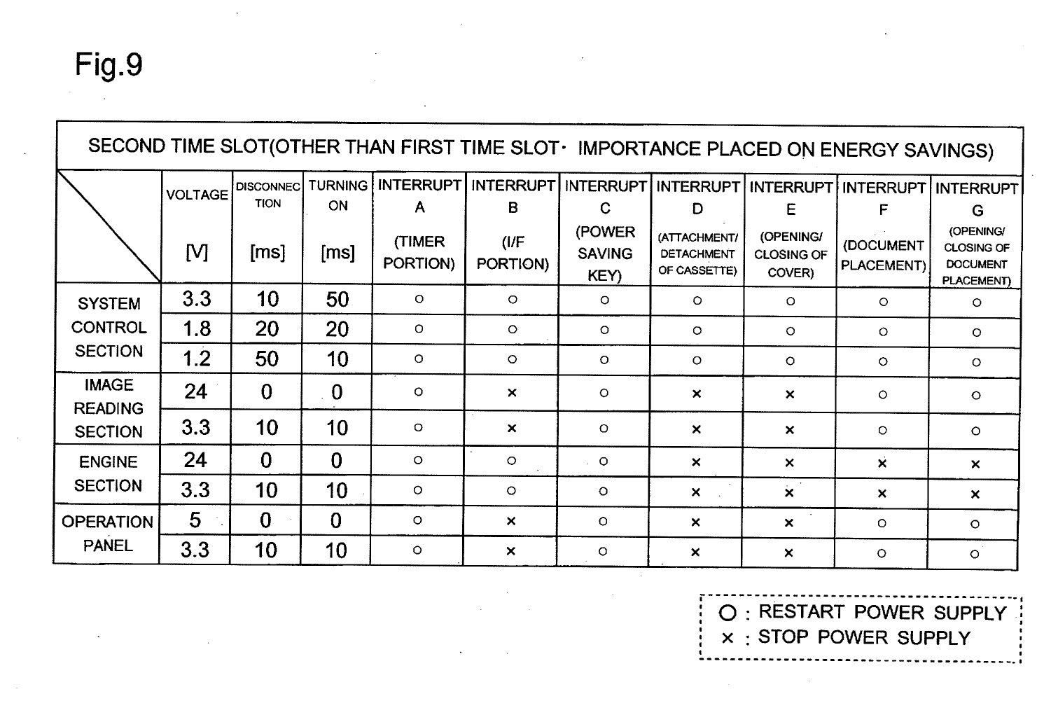

Next, FIG. 5, FIG. 7, FIG. 8, and FIG. 9 are referenced to describe an outline of shift to the power saving mode and recovery from the power saving mode, which is performed on the multifunction peripheral 100 according to the embodiment of the present invention. FIG. 7 is a flowchart illustrating an example of the shift control from the normal mode to the power saving mode which is performed on the multifunction peripheral 100 according to the embodiment of the present invention. FIG. 8 and FIG. 9 are explanatory diagrams illustrating an example of a power control table according to the embodiment of the present invention.

The multifunction peripheral 100 has a normal mode in which, for example, the system control section 7 and all the functional blocks are normally maintained in a state of being supplied with power. For example, in the normal mode, the power control section 9 supplies power to the engine section 8, and the engine control portion 80 turns on/off the heater of the fixing portion 6 to thereby perform control to maintain the fixing portion 6 at a temperature that allows fixation. In the normal mode, all functions of the multifunction peripheral 100 are available.

Here, from the viewpoint of energy savings, consumers are now taking the level of power consumption in a standby state (standby power) into consideration for choosing the image forming apparatus. Further, in the normal mode, even when the multifunction peripheral 100 is not used, the power is consumed because the temperature of the fixing portion 6 is maintained and the respective control sections are in a driven state. For this reason, the multifunction peripheral 100 of this embodiment has a power saving mode in which the power consumption is positively reduced compared to the normal mode. Therefore, FIG. 7 is referenced to describe an example of the shift control from the normal mode to the power saving mode.

First, the start of FIG. 7 is a point in time when the normal mode starts, for example, when the multifunction peripheral 100 is activated by turning on the main power or when the normal mode is recovered from the power saving mode. Then, the system control section 7 communicates with the operation panel 2 to check whether or not the power saving key 23 is depressed (Step #1). When the power saving key 23 is depressed (Yes in Step #1), the procedure advances to Step #3 (as described later in detail).

On the other hand, when the power saving key 23 is not depressed (No in Step #1), the system control section 7 checks whether or not a fixed time (the fixed time being, for example, several minutes to several tens of minutes, is measured by, for example, the timer portion 74 and can be set by the operation panel 2) has elapsed since a predetermined start point without any operation or any input being performed with respect to the multifunction peripheral 100 (Step #2). Specifically, the system control section 7 performs communications with the respective functional blocks, or receives an output from the sensor of the respective functional blocks, to thereby check whether or not there is an operation or an input performed with respect to the multifunction peripheral 100 such as the document placement on the document transport device 200, the closing/opening of the document transport device 200, the closing/opening of the front cover, the attachment/detachment of the cassettes 31 (31A and 31B) (including the optional cassette 300), the operation input to the operation panel 2, and the input of the image data performed from the external portion to the I/F portion 76.

Note that, a plurality of kinds are previously determined as the predetermined start point, for example, “when coming to a printable state after the main power is turned on”, “when coming to the printable state after the recovery from the power saving mode”, and “when a job is completed”. When the fixed time has not elapsed (No in Step #2), the procedure returns to, for example, Step #1.

On the other hand, when the fixed time has elapsed (Yes in Step #2) or when the power saving key 23 is depressed (Yes in Step #1), the multifunction peripheral 100 performs a preprocessing for the shift the normal mode to the power saving mode. Specifically, the system control section 7 provides the power control section 9 with the power control table (corresponding to data for power control) stored in the storage portion 72 and the HDD 77 (Step #3). In other words, the power control section 9 acquires the power control table from the system control section 7 (Step #3).

Note that, described here is an example in which the power control table is provided to the power control section 9 immediately before the shift from the normal mode to the power saving mode. However, alternatively, the power control table may be provided to the power control section 9, for example, at an arbitrary point in time (for example, during a loop between Step #1 and Step #2 in the flowchart) after the main power is turned on and after the system control section 7 and the power control section 9 have been activated. Then, the power control section 9 retains the power control table in the memory 92 or the like (Step #4).

Further, when the fixed time has elapsed since the predetermined start point without any operation or any input being performed with respect to the multifunction peripheral 100, the system control section 7 sends to the power control section 9 a stop permission notification that is a notification (data) for permitting the shift from the normal mode to the power saving mode (Step #5). Upon reception of the stop permission notification, the power control section 9 controls the switch portion 94 to stop the power supply to the system control section 7 and all the functional blocks based on the power control table (Step #6). This effects the shift to the power saving mode (end), which reduces the power consumption of the multifunction peripheral 100. Note that, the power control section 9 operates even in the power saving mode.

That is, the image forming apparatus according to the present invention (for example, multifunction peripheral 100) includes: a plurality of kinds of interrupt generation sections (such as I/F portion 76) that detect that an operation or an input has been performed with respect to the image forming apparatus, generates an interrupt, and transmits the interrupt to the power control section 9; and the timer portion 74 that measures time. In the above-mentioned image forming apparatus, the system control section 7 provides the power control section 9 with the stop permission notification that permits stopping of the power supply to the system control section 7 and the functional blocks (such as engine section 8, image reading section 1, operation panel 2, and various optional devices) when a predetermined time has elapsed without any interrupt being transmitted from any of the interrupt generation sections, and the power control section 9 stops the power supply to the system control section 7 and the functional block upon reception of the stop permission notification.

Note that, as illustrated in FIG. 5, the interrupt generation section that detects an input or an operation performed by the user with respect to the image forming apparatus 100 and generates an interrupt serving as the trigger for the recovery of the normal mode from the power saving mode is provided in the system control section 7 and the functional block. For example, in the example illustrated in FIG. 5, the interrupt generation section corresponds to the timer portion 74, the I/F portion 76, the power saving key 23 (the operation panel 2), the attachment/detachment detection sensor 34, the cover open/close detection sensor 43, the document placement detection sensor 206, and the like. Note that, in order to detect an input or an operation performed by the user even in the power saving mode, the power is kept being supplied to the respective interrupt generation sections even after the power supply to the system control section 7 or the functional block is stopped due to the shift to the power saving mode (in FIG. 5, the power supply system in the normal mode is indicated by the solid line and the power supply system in the power saving mode is indicated by the broken line).

Here, FIG. 8 and FIG. 9 are referenced to describe how the power control table stored in the power control section 9 is referenced during the shift to the power saving mode. As illustrated in FIG. 8 and FIG. 9, the power control table describes a sequence (order) for stopping the power supply to the system control section 7 and the respective functional blocks. Specifically, the power control table describes a time elapsing after reception of the stop permission notification until the application of various voltage values is stopped (“disconnection (ms)” in the third column of the tables of FIG. 8 and FIG. 9).

For example, with regard to the system control section 7, the power control section 9 controls the switch portion 941 for a system control section to stop DC 3.3 V (10 ms after the stop permission notification) used for the I/O blocks of the main CPU 71 or the like, DC 1.8 V (20 ms after the stop permission notification) also used for the I/O blocks of the main CPU 71 or the like, and DC 1.2 V used for the core of the main CPU 71 or the like in the stated order. The above-mentioned order is determined in consideration of a failure or a malfunction of the system control section 7. In addition, the order of the stopping is also determined with regard to the respective functional blocks (image reading section 1, engine section 8, and operation panel 2). Note that, FIG. 8 and FIG. 9 illustrate the example of the stopping is effected immediately after the reception of the stop permission notification because DC 24 V and DC 5 V are the voltages for driving the motor or operating the liquid crystal display portion 21.

(Interrupt)

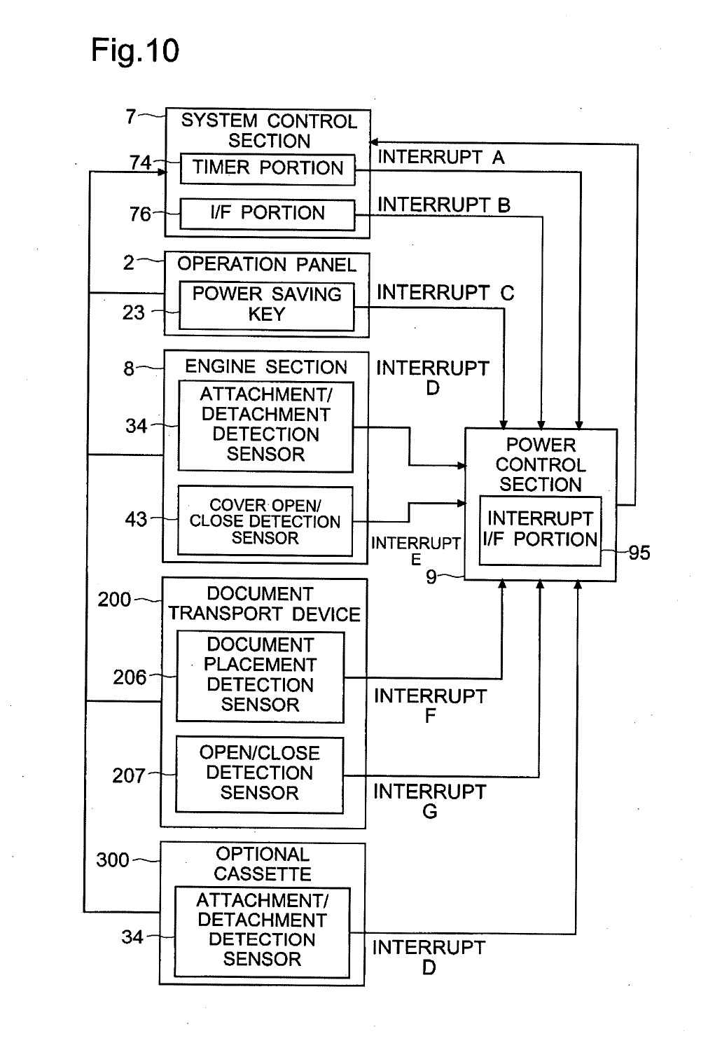

Next, FIG. 10 is referenced to describe an example of an interrupt serving as the trigger for the recovery from the power saving mode on the multifunction peripheral 100 according to the embodiment of the present invention. FIG. 10 is an explanatory block diagram of the interrupt according to the embodiment of the present invention.

Upon the shift to the power saving mode, the power supply to the system control section 7 and all the functional blocks is stopped. Therefore, the multifunction peripheral 100 is not available. Accordingly, the normal mode needs to be recovered from the power saving mode in order for the user to use the multifunction peripheral 100.

Then, the interrupt I/F portion 95 of the power control section 9 receives an interrupt (trigger) indicating that there is an operation performed by the user with respect to the multifunction peripheral 100 or an input of data performed from the external portion. When there is an interrupt, the power control section 9 restarts the power supply to the system control section 7 and the functional block in order to cause the multifunction peripheral 100 to recover the normal mode from the power saving mode.

Thus, FIG. 10 is referenced to describe an example of various interrupts. First, examples of the interrupt generation section within the system control section 7 include the timer portion 74. A setting regarding the recovery from the power saving mode caused based on a timer can be performed by being input to the operation panel 2 (for example, such a setting that the power saving mode is enabled during a lunch hour and the normal mode is recovered when a business is restarted). The timer portion 74 generates an interrupt at a time for the recovery from the power saving mode, and inputs the interrupt to the power control section 9 (interrupt A in FIG. 8, FIG. 9, and FIG. 10).

Further, the examples of the interrupt generation section within the system control section 7 also include the IN portion 76. The I/F portion 76 generates an interrupt when the image data for the printing and the data for the printing setting is input from the external computer 500 or the external FAX device 600, and inputs the interrupt to the power control section 9 (interrupt B in FIG. 8, FIG. 9, and FIG. 10).

Further, examples of the interrupt generation section within the operation panel 2 include the power saving key 23. When being depressed, the the operation panel 2 generates an interrupt, and inputs the interrupt to the power control section 9 (interrupt C in FIG. 8, FIG. 9, and FIG. 10). Note that, a part that generates the interrupt is not limited to the power saving key 23 and may be the power key 22, the touch panel, or the like.

Further, examples of the interrupt generation section within the engine section 8 and the optional cassette 300 include the attachment/detachment detection sensor 34 that detects attachment/detachment. Upon detection of attachment or detachment for the purpose of addition or exchange of paper, the attachment/detachment detection sensor 34 generates an interrupt, and inputs the interrupt to the power control section 9 (interrupt D in FIG. 8, FIG. 9, and FIG. 10). Further, the examples of the interrupt generation section within the engine section 8 include the cover open/close detection sensor 43 that detects the closing/opening of the cover. Upon detection of an operation (closing/opening) of the cover of a casing for the purpose of maintenance, exchange of a consumable item, or a removal processing for jammed paper, the cover open/close detection sensor 43 generates an interrupt, and inputs the interrupt to the power control section 9 (interrupt E in FIG. 8, FIG. 9, and FIG. 10).

Further, examples of the interrupt generation section within the document transport device 200 include the document placement detection sensor 206 that detects the document placement on the document placing tray 201 (interrupt F in FIG. 8, FIG. 9, and FIG. 10) and the open/close detection sensor 207 that detects lifting/lowering of the document transport device 200 (interrupt G in FIG. 8, FIG. 9, and FIG. 10). Upon detection of an operation (document placement or lifting/lowering) performed with respect to the document transport device 200 for the purpose of copying or the like, the document placement detection sensor 206 and the open/close detection sensor 207 generate interrupts, and input the interrupts to the power control section 9.

Note that, in the normal mode, the respective functional blocks may recognize the generation of an interrupt and notify the system control section 7 of the interrupt generation, or the output from the interrupt generation section may be input to the system control section 7.

(Recovery from Power Saving Mode)

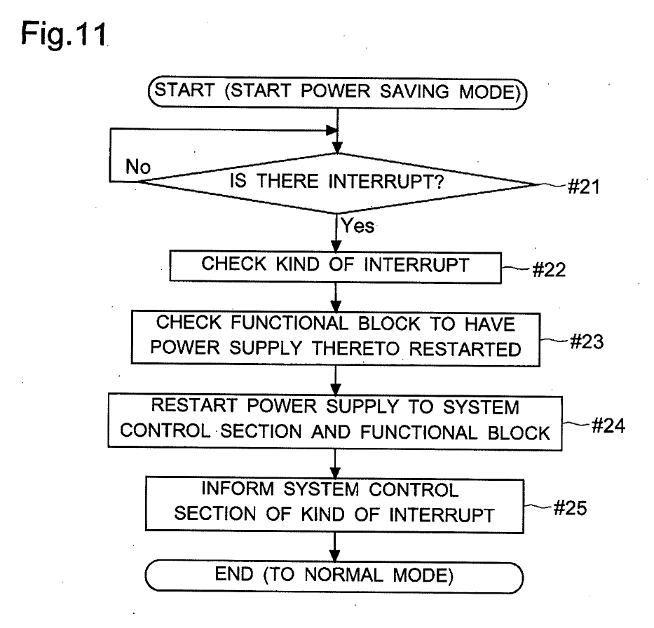

Next, FIG. 8, FIG. 9, and FIG. 11 are referenced to describe an example of the recovery from the power saving mode on the multifunction peripheral 100 according to the embodiment of the present invention. FIG. 11 is a flowchart illustrating an example of recovery control from the power saving mode to the normal mode which is performed on the multifunction peripheral 100 according to the embodiment of the present invention.

First, the start of FIG. 11 is a point in time when the power saving mode starts, for example, when the power supply to the system control section 7 and all the functional blocks is stopped. Then, the power control section 9 checks whether or not an interrupt has been received from each of the interrupt generation sections (Step #21). Then, the power control section 9 keeps checking until the interrupt is received (loop of No in Step #21→Step #21).

When the interrupt is received, the power control section 9 checks the kind of the interrupt (Step #22). In other words, the power control section 9 checks which one of the interrupt generation sections the interrupt has been received from, for example, whether or not the power saving key 23 has been depressed, whether or not the cassettes 31 (31A and 31B) has been attached/detached, whether or not the image data has been input from the external computer 500, or the like (Step #22).

In addition, the power control section 9 checks the power control table retained in the memory 92 to check the functional block to have the power supply thereto restarted (recovered) (Step #23). Then, based on the power control table, the power control section 9 restarts the power supply to the system control section 7 and the functional block (Step #24).

Here, FIG. 8 and FIG. 9 are referenced to describe the power control table in detail. First, on the multifunction peripheral 100 of this embodiment, irrespective of the kind of the interrupt, the power control section 9 restarts the power supply to the system control section 7 at the recovery from the power saving mode in order to perform overall control and recognition of the kind of the interrupt. As illustrated in FIG. 8 and FIG. 9, the power control table defines that all kinds of the voltages are to be turned on irrespective of the kind of the interrupt. Note that, in FIG. 8, FIG. 9, the symbol “◯” means that the power supply is turned on (supply is restarted) at the recovery of the normal mode from the power saving mode, and the symbol “x” means that the power supply is not turned on (supply remains stopped).

As illustrated in FIG. 8 and FIG. 9, the power control table defines the functional blocks to have the power supply thereto restarted in association with the kinds of the interrupts. Note that, as illustrated in FIG. 8 and FIG. 9, the power control table may define that the power supply to the functional block is not restarted when the normal mode is recovered, depending on the kind of the interrupt.

For example, the power control table illustrated in FIG. 8 and FIG. 9 defines that the power control section 9 restarts the power supply to the system control section 7 and all the functional blocks when the normal mode is recovered from the power saving mode by use of the interrupt (interrupt A) based on the time measured by the timer portion 74 or the interrupt (interrupt C) based on the depression of the power saving key 23 as the trigger.

On the other hand, for example, the power control table illustrated in FIG. 8 and FIG. 9 defines that the power control section 9 restarts the power supply to the system control section 7 and the engine section 8 among the functional blocks when the normal mode is recovered from the power saving mode by use of the interrupt (interrupt B) received from the I/F portion 76 based on the reception of the image data from the external computer 500 or the other party's FAX device 600 as the trigger. This is because the image reading section 1 or the operation panel 2 are hardly used when the printing is performed by a printer or performed for FAX reception.

As described above, when the normal mode is recovered from the power saving mode, the functional block to have the power supply thereto restarted is appropriately defined by the power control table in consideration of the user's using manner, necessity, use frequency, and the like with regard to the interrupt. Accordingly, on the multifunction peripheral 100 of this embodiment, when the normal mode is recovered from the power saving mode, not all the functional blocks necessarily have the power supply thereto restarted. For this reason, it is possible to achieve reduction in the power consumption of the multifunction peripheral 100. In other words, the power control table can define that only the functional block considered to be necessary is to have the power supply thereto restarted according to the kind of the interrupt.

That is, data for power control (power control table) includes data defining the functional block to have the power supply thereto restarted according to the kind of the generated interrupt when the interrupt is generated under a state in which the power supply to the system control section 7 and the functional blocks (such as engine section 8, image reading section 1, operation panel 2, and various optional devices) is stopped. Further, the data for power control includes data defining that the power supply to the system control section 7 is restarted irrespective of the kind of the generated interrupt when the interrupt is generated under the state in which the power supply to the system control section 7 is stopped.

Further, as illustrated in FIG. 8 and FIG. 9, the power control table may define the functional block to have the power supply thereto restarted according to the kind of the interrupt for each of time slots. FIG. 8 and FIG. 9 illustrate examples in which two time slots are provided. A first time slot (AM 9:00 to PM 5:00; the power control table of FIG. 8) representing business hours is the example of placing importance on responsiveness of the multifunction peripheral 100, and a second time slot (time that does not belong to the first time slot; the power control table of FIG. 9) is the example of placing importance on the power saving.

That is, the data for power control (power control table) includes the data defining the functional blocks (for example, engine section 8, image reading section 1, operation panel 2, and various optional devices) to have the power supply thereto restarted according to the kind of the generated interrupt for each of the time slots.

As is apparent from a comparison between the first time slot (FIG. 8) and the second time slot (FIG. 9), in the examples illustrated in FIG. 8 and FIG. 9, the number of “x” is larger in the second time slot than in the first time slot in order to produce a greater power saving effect. With regard to the attachment/detachment of the cassettes 31 (31A and 31B) performed for the purpose of the printing with added paper or changed paper size, for example, with regard to the interrupt (interrupt D) ascribable to the attachment/detachment of the cassettes 31 (31A and 31B), the power supply to the engine section 8 is restarted in the first time slot, but in the second time slot, the power supply to the engine section 8 as the functional block is not restarted for the power saving. Further, for example, with regard to the interrupt (interrupt E ascribable to the operation (closing/opening) of the cover of the casing, the power supply to the engine section 8, and the operation panel 2 is restarted in the first time slot, but in the second time slot, the power supply to the engine section 8 and the operation panel 2 as the functional blocks is not restarted for the power saving.

That is, the time slots used in the data for power control (power control table) include at least two kinds of a midnight time slot and a time slot other than the midnight time slot, and the data for power control corresponding to the midnight time slot is defined so as to have a smaller number of the functional blocks to have the power supply thereto restarted than that corresponding to the time slot other than the midnight time slot.

Note that, when the normal mode is recovered from the power saving mode, there is a case where the power supply to a part or all of the functional blocks is not restarted. With regard to the functional block remaining in the power supply stopped state, for example, in the normal mode, the power control section 9 may restart the power supply to the functional block in the power supply stopped state when an interrupt defining that the power supply to the functional block in a power supply stopped state is to be restarted is generated. Alternatively, in a case where there is the functional block remaining in the power supply stopped state, the power control section 9, when any interrupt (any kind of interrupt) is generated, the power supply to the functional block remaining in the power supply stopped state may be restarted in the normal mode.

In the above-mentioned manner, based on (by referencing) the power control table, the power control section 9 restarts the power supply to the system control section 7 and the functional block (Step #24).

Here, FIG. 8 and FIG. 9 are referenced to describe the order (sequence) of recovering the normal mode. As illustrated in FIG. 8 and FIG. 9, the power control table also describes the sequence (order) of restarting the power supply to the system control section 7 and the respective functional blocks. Specifically, the power control table describes a time to start applying the various voltage values when the power supply is restarted (“turning on (ms)” in the fourth column of the tables of FIG. 8 and FIG. 9).

For example, with regard to the system control section 7, the power control section 9 controls the switch portion 941 for a system control section to restart (turn on) DC 1.2 V (for example, 10 ms after the interrupt generation) used for the core of the main CPU 71 or the like, DC 1.8 V (for example, 20 ms after the interrupt generation) used for the I/O blocks or the like, and DC 3.3 V also used for the I/O blocks of the main CPU 71 or the like in the stated order. The above-mentioned order of the power supply is determined in consideration of a failure or a malfunction of the system control section 7. In this example, the malfunction is prevented by turning on the I/O after a logic for the core of the main CPU 71 is determined.

In addition, the order of restarting the supply is also determined with regard to the respective functional blocks (image reading section 1, engine section 8, and operation panel 2). Note that, FIG. 8 and FIG. 9 illustrate the examples of immediately restarting the power supply because DC 24 V and DC 5 V are the voltages for driving the motor or operating the liquid crystal display portion 21. That is, one or a plurality of kinds of voltages are supplied to the system control section 7 and the respective functional blocks (engine section 8, image reading section 1, operation panel 2, and various optional devices), the power control section 9 performs switching on/off of the voltages supplied to the system control section 7 and the respective functional blocks, and the data for power control (power control table) includes data defining the order of turning on the voltages when the power supply is started and the order of turning off the voltages when the power supply is stopped with regard to the system control section 7 and the respective functional blocks to which the plurality of kinds of voltages are supplied.

After the power supply to the system control section 7 and the like is restarted and the system control section 7 is activated (for example, after several hundreds of milliseconds to several seconds have elapsed), the power control section 9 informs the system control section 7 of the kind of the interrupt serving as the trigger for the recovery of the normal mode from the power saving mode (Step #25). That is, an interrupt is generated under the state in which the power supply to the system control section 7 is stopped, and hence the power control section 9 notifies the system control section 7 of the kind of the interrupt when the power supply to the system control section 7 is restarted. After that, the normal mode is effected (end).

(Setting Performed by User on Power Control Table)

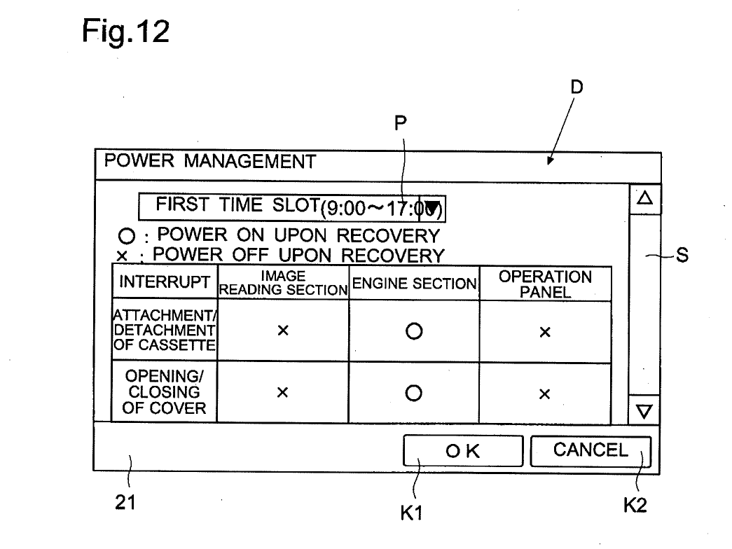

Next, FIG. 12 is referenced to describe an example of settings performed by the user on the power control table in the multifunction peripheral 100 according to the embodiment of the present invention. FIG. 12 is an explanatory diagram illustrating an example of a setting screen D of the power control table which is displayed on the multifunction peripheral 100 according to the embodiment of the present invention.

First, FIG. 12 illustrates the example of the setting screen D for power management which is displayed on the liquid crystal display portion 21 of the operation panel 2. For example, the setting screen D is displayed by repeating selection of a key displayed on the liquid crystal display portion 21. The user can change contents of the power control table through the setting screen D.

For example, a pull-down menu P is provided in an upper part of the setting screen D. When the pull-down menu P is depressed, the time slots are displayed. The user can select the time slot for which the settings are to be performed. Note that, FIG. 12 illustrates the example of the setting screen D of the first time slot (FIG. 8) out of the power control tables illustrated in FIG. 8 and FIG. 9.

Further, on the setting screen D, it is possible to set the kind of the interrupt and whether or not the power supply to the respective functional blocks (in the example of FIG. 12, three kinds of the image reading section 1 (scanner), the engine section 8, and the operation panel 2 are exemplified as the functional blocks) is performed when the normal mode is recovered from the power saving mode. For example, a box showing the symbol “◯” within the table is depressed to switch to “x”, and a box showing the symbol “x” is depressed to switch to “◯”. It is possible to set the contents of the power control table by depressing the respective boxes.

Note that, with a plurality of kinds of interrupts and a limited display area of the liquid crystal display portion 21, it may be difficult to view the setting screen D and to perform a setting in a case where all the interrupts are displayed within one screen. For this reason, a scroll bar S is provided in a right-end part of the setting screen D. It is possible to display a screen regarding the other interrupts by depressing the scroll bar S.

Then, an OK key K1 and a cancel key K2 are provided in a lower part of the setting screen D. The OK key K1 is depressed to complete the settings, and the cancel key K2 is depressed to abandon the changes in the settings that have been performed on the power control table.

When the OK key K1 is depressed, the panel control portion 20 of the operation panel 2 recognizes setting contents, and transmits data indicating the setting contents (newly-set power control table) to the system control section 7. Then, the system control section 7 causes the storage portion 72 and the HDD 77 to update and store the newly-set power control table. After that, the power control section 9 is provided with the new power control table by the system control section 7 before the shift from the normal mode to the power saving mode. Then, the power control section 9 performs the power supply management based on the new power control table.

That is, the image forming apparatus according to the present invention (for example, multifunction peripheral 100) includes the setting input section (operation panel 2) for performing settings regarding the image forming apparatus, and the setting input section (operation panel 2) receives an input for changing the data for power control (power control table).

In the above-mentioned manner, the image forming apparatus according to the present invention (for example, multifunction peripheral 100) includes: the system control section 7 that performs control of the image forming apparatus; the functional blocks (such as engine section 8, image reading section 1, operation panel 2, and various optional devices) that communicate with the system control section 7 and form a part of the image forming apparatus; and the power control section 9 that is communicably connected to the system control section 7 and controls the power supply to the system control section 7 and the functional block. In the above-mentioned image forming apparatus, the system control section 7 provides the power control section 9 with the data for power control (power control table) defining with regard to the power supply to the system control section 7 and the functional block, and the power control section 9 controls the power supply to the system control section 7 and the functional block based on the data for power control.

According to the configuration, the power control section 9 controls the power supply and the stopping thereof through the data for power control, and hence the data for power control may be set in the same manner for the functional block common between the models, and the data for power control (power control table) may be separately set in a case of using the functional block specific to the model (for example, optional device). In other words, differences between the models are absorbed into the data for power control provided by the system control section 7. Accordingly, it is possible to reduce man-hours required for development of the power management such as designing of the power control section 9 for each of the models of the image forming apparatus (for example, multifunction peripheral 100) and creation of a program for operating the power control section 9, which can reduce development costs of the image forming apparatus. Further, it is possible to simplify a power management system for the image forming apparatus. Further, the power control section 9 can achieve generalization and commonality between the models independently of the model. In addition, it is possible to reduce manufacture costs of the image forming apparatus by mass production and the like owing to the simplification of the power management system and the commonality of the power control section 9 between the models.

Further, the system control section 7 provides the stop permission notification to the power control section 9. This substantially allows the system control section 7 to perform the power management, such as mode switching, for the image forming apparatus (for example, multifunction peripheral 100). Further, the configuration of the power control section 9 can be simplified because the power control section 9 operates based on only the data for power control (power control table) and the stop permission notification. Further, the data for power control can define the functional block to have the power supply thereto restarted according to the kind of the interrupt. In other words, the power supply to the system control section 7 and all the functional blocks is not collectively turned on/off. Accordingly, the power management can be finely performed, which can produce a high power saving effect.

Further, with regard to the stopping of the power supply to the respective functional blocks (engine section 8, image reading section 1, operation panel 2, and various optional devices) being performed based on the stop permission notification, the stop permission notification is transmitted from the system control section 7 to the power control section 9 every time conditions are satisfied. This substantially allows the system control section 7 to perform the power management, which can simplify the configuration of the power control section 9.

Further, the data for power control (power control table) is prepared for each of the time slots, and hence the power supply control can be finely performed in consideration of actual use of the multifunction peripheral 100 depending on the time slot. Specifically, in consideration that the multifunction peripheral 100 is rarely used in the midnight hours, the data for power control (power control table) corresponding to the midnight time slot is defined so as to have a smaller number of the functional blocks to have the power supply thereto restarted than that corresponding to the time slot other than the midnight time slot. Accordingly, it is possible to produce a high power saving effect in consideration of the actual use depending on the time slot.

Further, by receiving the notification of the kind of the interrupt, the system control section 7 that is communicably connected to the respective functional blocks is allowed to know the kind of the generated interrupt. Further, the data for power control includes the data defining the order of turning on/off of the voltages when the power supply is started, and hence the power control section 9 can restart and stop the power supply to the system control section 7 and the respective functional blocks without a problem. Further, the setting input section (operation panel 2) receives the input for changing the data for power control, and can therefore perform the power management as intended by the user. For example, the user can perform the setting that places importance on the responsiveness enabling a job to be immediately executed and the setting that places importance on the reduction in the power consumption.

In the above, the embodiment of the present invention has been described. However, the scope of the present invention is not limited thereto, and the present invention may be implemented by being subjected to various modifications without departing from the gist of the present invention.

For example, the above-mentioned description is directed to the example in which the recovery of the normal mode from the power saving mode (cancellation of power saving mode) is performed by the depression of the power saving key 23, but the recovery of the normal mode from the power saving mode (cancellation of power saving mode) may be performed by the depression of the power key 22 in the power saving mode in addition to the power saving key 23. In this case, the power key 22 also becomes one of the interrupt generation sections, and the power key 22 is defined in the power control table as one of the interrupts.

What is claimed is:

1. An image forming apparatus, comprising:
a system control section that performs control of the image forming apparatus;
a functional block that communicates with the system control section and forms a part of the image forming apparatus; and
a power control section that is communicably connected to the system control section, that controls power supply to the system control section and the functional block, that is provided with data for power control defining with regard to the power supply to the system control section and the functional block by the system control section, and that controls the power supply to the system control section and the functional block based on the data for power control.

2. An image forming apparatus according to claim 1, further comprising:
a plurality of kinds of interrupt generation sections that detect that an operation or an input has been performed with respect to the image forming apparatus to generate an interrupt, and transmits the interrupt to the power control section; and
a timer portion that measures time, wherein:
the system control section provides the power control section with a stop permission notification that permits stopping of the power supply to the system control section and the functional block when a predetermined time has elapsed without any interrupt being transmitted from any of the interrupt generation sections; and
the power control section stops the power supply to the system control section and the functional block upon reception of the stop permission notification.

3. An image forming apparatus according to claim 2, wherein the data for power control comprises data defining the functional block to have the power supply thereto restarted according to a kind of the generated interrupt when the interrupt is generated under a state in which the power supply to the system control section and the functional block is stopped.

4. An image forming apparatus according to claim 2, wherein the data for power control comprises data defining that the power supply to the system control section is restarted irrespective of the kind of the generated interrupt when the interrupt is generated under the state in which the power supply to the system control section is stopped.

5. An image forming apparatus according to claim 2, wherein the data for power control comprises data defining the functional block to have the power supply thereto restarted according to the kind of the generated interrupt for each of time slots.

6. An image forming apparatus according to claim 5, wherein:
the time slots used in the data for power control comprise at least two kinds of a midnight time slot and a time slot other than the midnight time slot; and
the data for power control corresponding to the midnight time slot is defined so as to have a smaller number of the functional blocks to have the power supply thereto restarted than that corresponding to the time slot other than the midnight time slot.

7. An image forming apparatus according to claim 2, wherein the power control section notifies the system control section of the kind of the interrupt when the power supply to the system control section is restarted because the interrupt is generated under the state in which the power supply to the system control section is stopped.

8. An image forming apparatus according to claim 1, wherein:
one or a plurality of kinds of voltages are supplied to the system control section and the respective functional blocks;
the power control section performs switching on/off of the voltages supplied to the system control section and the respective functional blocks; and
the data for power control comprises data defining an order of turning on the voltages when the power supply is started and an order of turning off the voltages when the power supply is stopped with regard to the system control section and the respective functional blocks to which the plurality of kinds of voltages are supplied.

9. An image forming apparatus according to claim 1, further comprising a setting input section for performing settings regarding the image forming apparatus,
wherein the setting input section receives an input for changing the data for power control.

10. A power supply control method for an image forming apparatus, comprising:
providing, by a system control section that performs control of the image forming apparatus, data for power control defining with regard to the system control section, a functional block that forms a part of the image forming apparatus, and the power supply to the functional block, to a power control section that is communicably connected to the system control section and controls power supply to the system control section and the functional block; and
controlling, by the power control section, the power supply to the system control section and the functional block based on the data for power control.

11. A power supply control method for an image forming apparatus according to claim 10, further comprising:
generating an interrupt when an operation or an input has been performed with respect to the image forming apparatus;
transmitting the interrupt to the power control section;
measuring time;
providing the power control section, by the system control section, with a stop permission notification that permits stopping of the power supply to the system control section and the functional block when a predetermined time has elapsed without any interrupt being transmitted; and
stopping, by the power control section, the power supply to the system control section and the functional block upon reception of the stop permission notification.

12. A power supply control method for an image forming apparatus according to claim 11, wherein the data for power control comprises data defining the functional block to have the power supply thereto restarted according to a kind of the generated interrupt when the interrupt is generated under a state in which the power supply to the system control section and the functional block is stopped.

13. A power supply control method for an image forming apparatus according to claim 11, wherein the data for power control comprises data defining that the power supply to the system control section is restarted irrespective of a kind of the generated interrupt when the interrupt is generated under the state in which the power supply to the system control section is stopped.

14. A power supply control method for an image forming apparatus according to claim 11, wherein the data for power control comprises data defining the functional block to have the power supply thereto restarted according to a kind of the generated interrupt for each of time slots.

15. A power supply control method for an image forming apparatus according to claim 14, wherein:
the time slots used in the data for power control comprise at least two kinds of a midnight time slot and a time slot other than the midnight time slot; and
the data for power control corresponding to the midnight time slot is defined so as to have a smaller number of the functional blocks to have the power supply thereto restarted than that corresponding to the time slot other than the midnight time slot.

16. A power supply control method for an image forming apparatus according to claim 11, wherein the power control section notifies the system control section of a kind of the interrupt when the power supply to the system control section is restarted because the interrupt is generated under the state in which the power supply to the system control section is stopped.

17. A power supply control method for an image forming apparatus according to claim 10, wherein:
one or a plurality of kinds of voltages are supplied to the system control section and the respective functional blocks;
the power control section performs switching on/off of the one or the plurality of kinds of voltages supplied to the system control section and the respective functional blocks; and
the data for power control comprises data defining an order of turning on the voltages when the power supply is started and an order of turning off the voltages when the power supply is stopped with regard to the system control section and the respective functional blocks to which the plurality of kinds of voltages are supplied.

18. A power supply control method for an image forming apparatus according to claim 10, further comprising receiving an input for changing the data for power control.
